(19) United States
(12) Patent Application Publication
(10) Pub. No.: US 2015/0349976 A1
(43) Pub. Date: Dec. 3, 2015

(54) METHOD OF INTERACTION BETWEEN A GROUP OF USERS AND AN AUTOMATIC SYSTEM

(71) Applicant: Orange, Paris (FR)

(72) Inventors: Francois Toutain, Louannec (FR); Emmanuel Le Huerou, Saint Quay Perros (FR)

(21) Appl. No.: 14/722,813

(22) Filed: May 27, 2015

(30) Foreign Application Priority Data
May 27, 2014 (FR) 1454775

(51) Int. Cl. H04L 12/28; G05B 19/042

(52) U.S. Cl. CPC H04L 12/2838; G05B 19/042; G05B 2219/2613

(57) ABSTRACT

A method of validating an action determined by a rules engine of a home automation server that is adapted to select an action from a trigger event and from an associated rule. A rule is also associated with a validation policy for validating the execution of the action. When an action is selected the method includes: generating at least one interface on the basis of the validation policy associated with the rule; transmitting the at least one validation interface to at least one terminal associated with the home automation server; receiving information about validating the action coming from the at least one terminal; and executing the action when the rule is validated in compliance with the validation policy.

### TECHNICAL FIELD

The present disclosure belongs to the field of home automation and relates more particularly to a method of validating an action decided on by an automatic system.

### PRIOR ART

Nowadays, home automation systems are becoming more widespread. They serve in particular to achieve energy savings and to improve home comfort.

There exist manual control systems that associate home automation equipment with a user interface, such as a remote control or an application on a smartphone, for example. The application enables the user to control the equipment, e.g. to open the door of a garage, or to open roller blinds, or indeed to switch heating on and off.

Other systems serve to adapt the home environment to a lifestyle. For example, certain home automation systems enable scenarios to be programmed as a function of user habits. For example, on leaving home in the morning, a simple press on a switch installed in the entrance triggers the “going to work” scenario: lighting is switched off, the garage opens, heating is put on standby after a few minutes, and then the blinds and the garage close after 30 minutes. In the evening, on leaving work, it is possible remotely to trigger a “coming home” scenario using a connected terminal such as a smartphone or an office computer: the blinds open and heating switches to comfort mode.

There have been approaches to “intelligent” management of a house that enable the dwelling to react automatically to certain events. Such extremely comprehensive systems generally incorporate a series of sensors, such as inside and outside temperature sensors, sensors for sensing light level, presence, smoke, etc. . . . . Thus, the home automation system of the dwelling can automatically activate certain scenarios on the basis of contextual information. For example, if a strong wind begins to blow, then the system can automatically wind in an awning on a terrace to avoid it being damaged. Likewise, the system can open or close blinds as a function of the position of the sun and of the season, so as to optimize energy consumption.

Nevertheless, such intelligent management systems are confronted with a thorny problem of the “exceptional situation” type. The intelligence provided by presently-existing practical approaches is not sufficiently advanced, and the situation as perceived by the system is not sufficiently complete for it to take account of all of the aspects of a situation and be sure that the automatic action as triggered is appropriate.

For example, a system that is capable of detecting that household members are out and that the lights are still on may switch them off automatically. However, if a guest is also in the house, that person might not necessarily be detected and would suffer the annoyance of being forced to stay in the dark.

There thus exists a need for a system for enabling the users of a home automation system to interact with an automatic system in order to validate the decisions taken by the automatic system.

### SUMMARY

To this end, the disclosure relates to a method of validating an action as determined by a rules engine of a home automation server adapted to select an action from a trigger event and from an associated rule, the method being such that a rule is also associated with a validation policy for validating execution of the action and that, on an action being selected, the method comprises steps of searching a database for a set of users entitled to validate the action, of generating, for each user of the set, at least one interface that is personalized depending on that user's entitlement to validate the action and on the basis of the validation policy associated with the rule, and of sending the at least one validation interface to at least one terminal associated with the user; of receiving information about validation of the action coming from at least one terminal; and executing the action when the rule is validated in compliance with the validation policy.

In conventional manner, when an event is detected by the home automation server, it searches for a rule that is associated with the event. By way of example, the rules may be stored in a database. On the basis of the rule and of the detected event, the home automation server determines an action to be executed in response to the event. According to an exemplary embodiment, execution of the action depends on that action being validated by at least one user having a terminal that is associated with the home automation server and in application of a validation policy. In order to enable the action to be validated, the home automation server generates a user interface that is adapted to the validation policy for validating that action. For example, the system may generate an interface, e.g. a graphics interface or indeed a voice interface, that presents contact information useful for validating the action so that the various users having terminals associated with the home automation server can validate or invalidate the action before it is executed. Thus, the method enables users having a terminal associated with the home automation server to validate or to invalidate an automatic action.

In a particular implementation, the method is such that the validation policy is defined by at least one set of users entitled to validate the action and/or by a validation quorum.

The validation policy associated with a rule makes it possible to specify a set of users entitled to validate an action together with stipulations for such validation. For example, the set of users entitled to validate actions relating to a heating system may be constituted by only the parents of the household. Still by way of example, when the action to be validated is switching off lights that have been left on in a dwelling when nobody is present, then the set of users entitled to validate the action may be constituted by all of the members of the household, both parents and children. It is thus possible to target accurately which users are able to validate the action.

The validation policy may also include a quorum. Thus, whereas certain actions may be validated by a single user from among the entitled users, other actions may require unanimity.

Thus, a home automation system performing the validation method advantageously approaches only those users who are entitled to validate any particular action, and enforces compliance with a quorum before validating a given action.

In a particular implementation, the method is such that generation of the interface is adapted to at least one set of users defined by the validation policy.

The interface generated for a given user depends on that user's entitlement to validate the action. For example, when a system detects a rise in temperature, an interface for validating the action of stopping heating may be generated and presented to the adults of a household, while another interface giving only information about the situation without any validation option may be generated and presented to the children. The method thus enables different members of a household to be informed or approached for validation in a manner that is selective depending on the type of action that is to be validated.

In a particular implementation, the method is such that the step of executing the action consists in canceling a previously executed action.

The method thus enables an action that has been performed beforehand to be validated a posteriori. For example, a home automation system may decide to open the door of the garage at the end of the day so as to enable a member of the household to park a car therein on coming home from work. A sensor associated with the garage door triggers a rule informing the various members of the household that the garage door is open. A particular interface can then be generated for sending to those members of the household who have a driver's license so as to enable the action of opening the garage door to be canceled when a member plans to come home late.

In a particular implementation, the method is such that the trigger event comes from a sensor connected to the home automation server.

The home automation system is connected to a set of sensors enabling it to evaluate physical magnitudes in the real world. By inferring information coming form the sensors on the basis of rules, the method can advantageously select actions to be carried out in response to that information. For example, the home automation system may be connected to an anemometer suitable for measuring wind speed and can thus take the decision to wind in an outside awning when the wind speed exceeds a predetermined value.

An exemplary embodiment also provides a device for validating an action determined by a rules engine of a home automation server adapted to select an action from a trigger event and from an associated rule, the device being such that the rule is associated with a validation policy for validating execution of the action and that the device comprises the following units: a unit for selecting an action on the basis of a trigger event; a unit for searching in a database for a set of users entitled to validate the action; a unit for acting for each user of the set, to generate at least one interface that is personalized depending on that user's entitlement to validate the action and on the basis of the validation policy associated with the rule, and to send the at least one validation interface to at least one terminal associated with the user; a unit for receiving information about validating the action from the at least one terminal; and a unit for executing the action when the rule is validated in compliance with the validation policy.

An exemplary embodiment also provides a server having at least one validation device as described above.

An exemplary embodiment also provides a home gateway including a server in accordance with the above description.

An exemplary embodiment also provides a computer program including instructions for executing the above-described validation method when the program is executed by a processor.

An exemplary embodiment also relates to a computer readable data medium storing a computer program including instructions for executing steps of the validation method.

The devices, servers, gateways, programs, and data media present advantages analogous to those of the corresponding method described above.

### LIST OF FIGURES

Other advantages and characteristics appear more clearly on reading the following description of a particular implementation given merely by way of non-limiting illustrative example, and from the accompanying drawings, in which:

FIG. 1 is a simplified illustration of a home automation system of a dwelling that is adapted to perform a particular implementation of the method for validating an action;

FIG. 2 shows the steps of the validation method in a particular implementation; and

FIG. 3 shows the architecture of a device implementing the validation method in a particular implementation.

### DETAILED DESCRIPTION OF A PARTICULAR IMPLEMENTATION

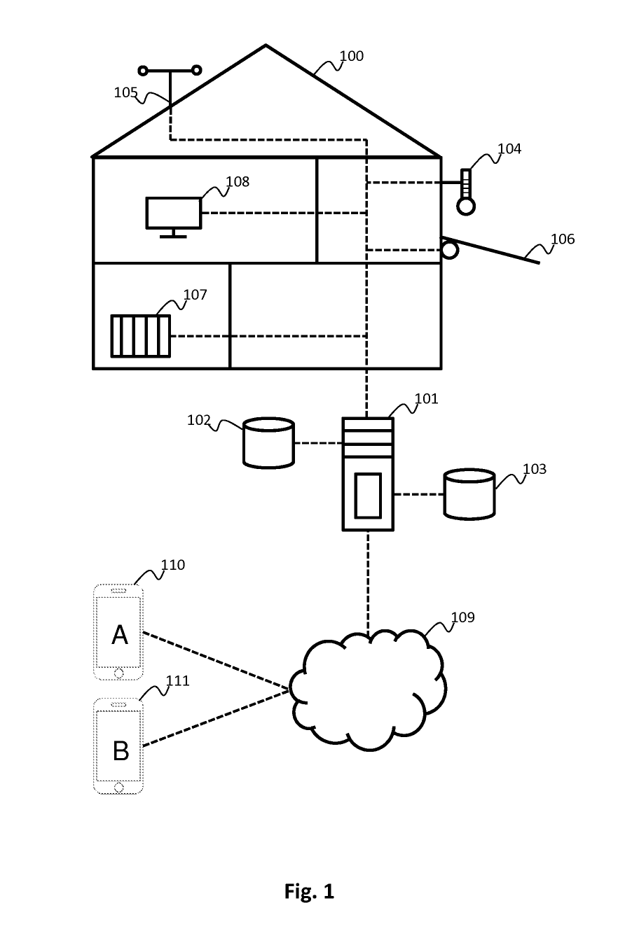

FIG. 1 shows a dwelling 100 having a home automation server 101 adapted to perform the method of an exemplary embodiment for validating an action.

The home automation server is connected to sensors, such as for example an anemometer 105 suitable for measuring wind speed and a thermometer 104 for measuring outside temperature. These sensors are mentioned as illustrative examples, and it should be understood that other types of sensor could also be used, such as for example detectors for detecting the opening of doors or windows, detectors for detecting smoke, light, or presence. The installation may also have sensors adapted to determine that a device such as a TV set, a games console, or a household appliance is switched on.

The home automation server is also connected to actuators adapted to perform actions. These actuators may for example be relays or motors, e.g. adapted to activate or deactivate a heating system 107, a computer 108, or indeed to wind out or in an outdoor awning 106.

By way of example, the sensors and the actuators may be connected by means of wireless links of the Bluetooth or WiFi type, or by using wired technologies of the Ethernet or carrier current type.

Thus, in conventional manner, the home automation server 101 can respond to external stimulations by acting on actuators in application of management rules. For example, the home automation server may wind in the awning 106 when the wind speed as detected by the anemometer 105 exceeds a certain value so as to avoid damage to the awning, it may switch off the heating 107 when the outside temperature as measured by the thermometer 104 exceeds a predetermined value, or it may switch off the computer 108 when no presence is detected in the dwelling.

The installation also has a first database 103 storing management rules enabling the server to perform actions in response to external stimulations detected by the various sensors. These rules contain, in particular, one or more trigger events, at least one trigger condition, a validation policy, and at least one action to perform when the conditions are satisfied and execution is validated in compliance with the validation policy. All of these rules, conditions, and validation policies are defined beforehand and stored in the home automation system, e.g. during a stage of configuring the system. Trigger events are contextual information obtained from sensors, such as for example the anemometer 105 or the thermometer 104. Contextual information may also be obtained from a calendar, a clock, a household appliance, the computer 108, or any other source capable of supplying contextual information. The conditions enable the home automation server to determine whether the situation requires a particular action to be executed. For example, the server may compare the wind speed as measured by the anemometer 105 with a predetermined value in order to decide whether or not to wind in the awning 106. The validation policy defines the autonomy of the home automation server concerning executing an action in response to a given situation. The validation policy information comprises a set of users who must give their agreement or be informed before the action is executed. These users may be referenced in the database 102, for example. By way of example, when the conditions are satisfied for the home automation system to stop the heating system 107, the validation policy may require the adults of the household to give their agreement before the action is indeed carried out. In a particular implementation, if the validation policy does not exist or if it does not specify any person entitled to validate the action, then the server may execute the action automatically. In another particular implementation, if there is no validation policy or if the policy does not specify any person entitled to validate the action, then the server may use a default validation policy specifying all of the referenced users and requiring, for example, that at least one of those users validates the action. In a particular implementation, the validation policy may also specify validation stipulations, e.g. by requiring a quorum. Thus, certain actions may need to be validated by some minimum number of people in order to be executed. For example, stopping the heating system 107 may require at least one adult to validate the action. Still by way of example, a validation policy may require unanimity among users specified in the validation policy prior to stopping the computer 108. Finally, a rule comprises one or more actions to be carried out when the conditions are satisfied and the decision is validated in application of the validation policy. The action may consist in activating physical equipment connected to the server, such as for example winding out the awning 106, operating lighting, or a household appliance, or indeed open a garage door. The action may also be digital in nature, e.g. consisting in adding a rendezvous to a diary, sending an email, downloading digital content from a server, or indeed placing an order with a supplier. The action may also be constituted by a plurality of sub-actions suitable for performing a scenario, such as for example opening the garage door, switching on the heating system, and opening the blinds at the end of the day in order to welcome household members coming home from a day's work.

A second database 102 contains information about the various people making up the household. For example, for a given person, the database specifies the equipment for which they are responsible, an identifier of the communications terminals used, or indeed usual departure and return times. Other characteristics of the users may be included in this database depending on the needs of the installation.

The home automation installation shown in FIG. 1 also has two terminals 110 and 111 connected to the home automation server 101 via a network 109, e.g. an Internet network. These terminals are adapted to display a validation interface managed by the home automation server 101.

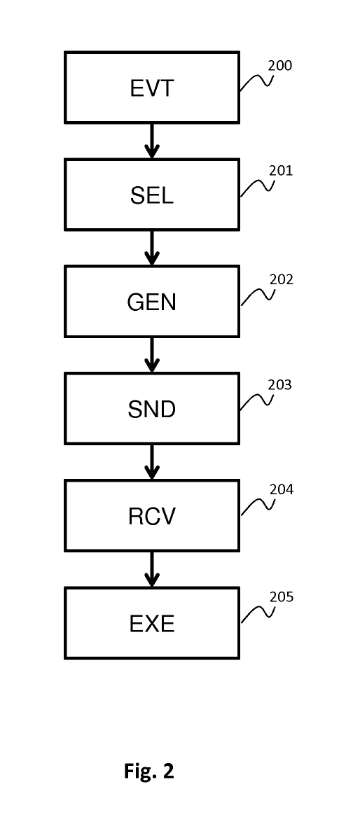

FIG. 2 shows the main steps of the validation method in a particular implementation. During a first step 200, the home automation server obtains an event from a context source. For example, the home automation server obtains a measurement of the temperature outside the dwelling from a temperature sensor such as the thermometer 104 of FIG. 1. The event may also be obtained from a household appliance or from a digital data source such as an on-line diary or a clock, for example. It may also be a communication event, such as receiving a telephone call or an email.

During the step 201, the home automation server searches for a rule that is associated with the event, e.g. by consulting the database 103. The event may be constituted by a combination of data coming from various context sources. When the home automation server identifies a rule corresponding to the event and when the conditions specified in the rule are satisfied, the server may identify an action to be executed in response to the event and a policy seeking to validate execution of that action. For example, after obtaining information from the anemometer 105, the system may identify a plurality of rules relating to that event, such as for example a rule that consists in winding in the awning when the wind speed exceeds a certain threshold, and a rule that consists in winding out the awning when the wind speed is less than a threshold. The server may then evaluate the conditions associated with those rules in order to determine which conditions are applicable to the situation. By way of example, those conditions may refer to measurements from various sensors, a time specified by a clock, or any other context information. Once the applicable rule(s) is/are identified, the system selects one or more actions to be carried out.

During a step 202, the home automation server consults a validation policy associated with the rule or with executing the action. The server must then submit execution of the action to at least one user specified by the validation policy and obtain agreement in compliance with predetermined validation stipulations prior to executing the action.

For this purpose, the server generates at least one interface from the validation policy associated with the rule. In a particular implementation, the validation interface is adapted to the various users specified in the validation policy. For example, it may be a graphics interface in the form of a hypertext markup language (HTML) document including a message outlining the situation that requires an action and the checks necessary for validating the rule. The interface may include other information that is useful for understanding the situation, such as for example a plan of the dwelling specifying the location of a trigger event, a photo from a surveillance camera, or indeed a video stream showing the situation. The interface generated for validating a particular action may differ from one user to another, e.g. as a function of criteria specified in the database 102. By way of example, these criteria may include the age of the user, the user's situation in the family (parent, child), and the equipment associated with the user. In a particular implementation, the interface that is generated may be for information purposes only for certain users and may request validation from other users. In a particular implementation, the interface may show certain validation stipulations. For example, a home automation system may request users to vote about a film for downloading in preparation for a family cinema evening, and under such circumstances it may propose a selection between multiple choices.

When the validation interfaces are generated in compliance with the validation policy, the home automation server sends those interfaces to the terminals of the users during a step 203. For this purpose, the server identifies the terminals associated with the users concerned, e.g. using information in the database 102, and then sends the interface data via the network 109. In a particular implementation, the home automaton server generates a notification sent to the terminals in order to attract the attention of users to the fact that a validation is expected from them. By way of example, this notification may be a message of the short message service (SMS) type, or it may be a notification of the push type appropriate for the destination terminal. On consulting the notification, the terminal can then download the validation interface and show it to the user.

In a step 204, the home automation server receives the responses from the users it has approached. When the responses comply with the validation stipulations, e.g. when the quorum is reached, the associated action is executed by the home automation server in a step 205.

In a particular implementation, the interfaces that are generated are dynamic. For example, they may be mutually synchronized and they may show the responses made by the various users, e.g. by displaying a counter enabling users to know when the quorum is reached. In a particular implementation, the interface ceases to be shown under certain conditions. For example, the interface may cease to be shown when the validation quorum is reached, when the action has been triggered directly by a user (for example, if the validation related to automatically closing a garage door and a person at the garage closes the door manually, then the validation interface can cease to be shown), or indeed when the conditions for triggering the rule are no longer present (e.g. if the validation is about winding in an awning because of a strong wind, the interface may cease to be presented if the wind speed drops).

In a particular implementation, the users have a time window during which it is possible to validate an action. At the end of the time window, the action may for example be executed automatically or it may be canceled automatically.

In a particular implementation, the responses given to the users and/or the interfaces shown to the users are stored so that they can be consulted subsequently.

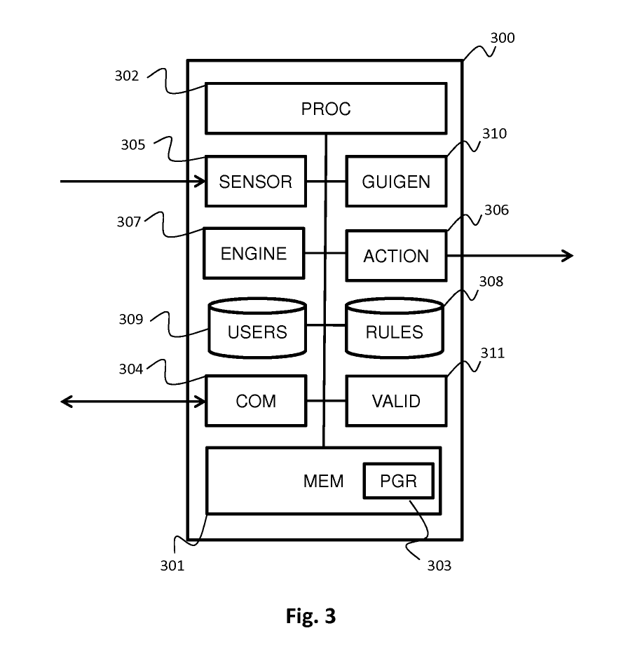

FIG. 3 shows the architecture of a device 300 adapted to perform the method in a particular implementation.

The device comprises a storage space 301, e.g. a memory MEM, and a processor unit 302 e.g. having a processor PROC. The processor unit may be controlled by a program 303, e.g. a computer program PGR, for performing the validation method as described with reference to FIG. 2, and in particular the steps of: generating at least one interface from the validation policy associated with the rule; sending the at least one validation interface to at least one terminal associated with the home automation server; receiving information concerning validation of the action from the at least one terminal; and executing the action when the rule is validated in compliance with the validation policy.

On initialization, the instructions of the computer program 303 are, for example, loaded into a random access memory (RAM) prior to being executed by the processor of the processor unit 302. The processor of the processor unit 302 performs the steps of the validation method in compliance with the instructions of the computer program 303.

For this purpose, in addition to the memory 301, the device has a communications module 304 (COM) enabling the device to connect to a communications network and to exchange data with other devices via the telecommunications network, and for example to send validation interfaces to the terminals and to receive corresponding responses from the terminals. This communications module may for example be a network interface of the WiFi or Ethernet type. The device also has a connection module 304 (SENSOR) for connecting with sensors and a connection module 306 (ACTION) for connecting with actuators. These connection modules may for example be interfaces of the network, Bluetooth, carrier current or indeed pilot wire type, for example, and they serve in particular to receive information from the sensors and to control the actuators in order to perform actions once they have been validated in compliance with the validation policy. The device also has a rule interpretation module 307 (ENGINE). This module serves in particular to search in a rules database 308 (RULES) of the device for rules associated with events obtained via the sensor connection module 305, to verify whether the conditions for triggering an action are satisfied, and to select an action to be carried out. The device also has a generator module 310 (GUIGEN) for generating at least one interface from a validation policy associated with a rule, and a user database 309 (USERS) serving in particular to store characteristics of users associated with the device. Finally, the device has a validation module 311 (VALID) serving to analyze the responses of users to requests for validation that have been sent in order to determine whether an action may be executed.

In a particular implementation, the device may be incorporated in a home automation server, a home gateway, a personal computer, or indeed any other equipment connected to a communications network and suitable for controlling actuators and for receiving information coming from sensors.

Although the present disclosure has been described with reference to one or more examples, workers skilled in the art will recognize that changes may be made in form and detail without departing from the scope of the disclosure and/or the appended claims.

1. A method of validating an action as determined by a home automation server executing a rule, the method comprising:
selecting an action from a trigger event and an associated rule, wherein a rule is also associated with a validation policy for validating execution of the action, the validation policy being defined by a set of users entitled to validate the action, and by a validation quorum; and
on an action being selected:
searching a database for a set of users entitled to validate the action;
for each user in the set, generating at least one interface that is personalized depending on that user's entitlement to validate the action and on the basis of the validation policy associated with the rule, and sending the at least one validation interface to at least one terminal associated with the user;
receiving information about validating the action coming from at least one terminal; and
executing the action when the rule is validated in compliance with the validation policy.

2. A method according to claim 1, wherein interface generation is adapted to the set of users defined by the validation policy.

3. A method according to claim 1, wherein executing the action comprises canceling a previously executed action.

4. A method according to claim 1, wherein the trigger event comes from a sensor connected to the home automation server.

5. A method performed on a terminal for confirming execution of an action determined as a result of a home automation system executing a rule, a rule being associated with a validation policy for validating execution of the action, the validation policy being defined by a set of users entitled to validate the action and by a validation quorum, the method being characterized in that the terminal is associated with the home automation server and that an entitlement is associated with the user of the terminal, and in that the method comprises:
receiving a validation interface generated from the validation policy depending on the entitlement of the user of the terminal;
detecting a validation action on the received interface; and
sending validation information to the home automation server.

6. A device for validating an action that has been determined as a result of a home automation server executing a rule for selecting an action from a trigger event and from an associated rule, the device being characterized in that the rule is associated with a validation policy for validating execution of the action, the validation policy being defined by a set of users entitled to validate the action and by a validation quorum, and in that the device comprises a processor unit, which is configured to:
select an action from a trigger event;
search in a database for a set of users entitled to validate the action;
generat for each user of the set, at least one interface that is personalized depending on that user's entitlement to validate the action, on the basis of the validation policy associated with the rule, and send the at least one validation interface to at least one terminal associated with the user;
receive information about validating the action from the at least one terminal; and
execute the action when the rule is validated in compliance with the validation policy.

7. A server including a device according to claim 6 for validating an action.

8. A home gateway including a server according to claim 7.

9. A non-transitory computer readable data medium storing a computer program including instructions for validating an action as determined by a home automation server executing a rule, when the program is executed by a processor, wherein the instructions comprise:
instructions that configure the processor to select an action from a trigger event and an associated rule, wherein a rule is also associated with a validation policy for validating execution of the action, the validation policy being defined by a set of users entitled to validate the action, and by a validation quorum; and
instructions that configure the processor to, on an action being selected:
search a database for a set of users entitled to validate the action;
for each user in the set, generate at least one interface that is personalized depending on that user's entitlement to validate the action and on the basis of the validation policy associated with the rule, and sending the at least one validation interface to at least one terminal associated with the user;
receive information about validating the action coming from at least one terminal; and
execute the action when the rule is validated in compliance with the validation policy.
